(19) United States
(12) Patent Application Publication
(10) Pub. No.: US 2024/0338530 A1
(43) Pub. Date: Oct. 10, 2024

(54) GENERATIVE DIALOG MODEL TRAINING METHOD AND APPARATUS AS WELL AS GENERATIVE DIALOG IMPLEMENTING METHOD AND APPARATUS

(71) Applicant: BEIJING BAIDU NETCOM SCIENCE TECHNOLOGY CO., LTD., Beijing (CN)

(72) Inventors: Zhen GUO, Beijing (CN); Wenquan WU, Beijing (CN); Hua WU, Beijing (CN); Haifeng WANG, Beijing (CN)

(73) Assignee: BEIJING BAIDU NETCOM SCIENCE TECHNOLOGY CO., LTD., Beijing (CN)

(21) Appl. No.: 18/745,550

(22) Filed: Jun. 17, 2024

(30) Foreign Application Priority Data
Jun. 30, 2023 (CN) 202310797318.6

(51) Int. Cl. G06F 40/35; G06N 20/00

(52) U.S. Cl. CPC G06F 40/35; G06N 20/00

(57) ABSTRACT

A generative dialog model training method in the fields of artificial intelligence, such as deep learning, natural language processing, intelligent dialogs, is disclosed. The generative dialog model training method may include: in response to determination of an update of a safety specification, taking an updated safety specification as a target safety specification, and determining a dialog input corresponding to a current optimization according to the target safety specification, the update being performed on a previous safety specification when a generative dialog model after last optimization is determined not to meet a launch requirement; and optimizing the generative dialog model according to the dialog input and a principle that a reply generated by the generative dialog model conforms to the target safety specification, the generative dialog model being configured to generate the reply corresponding to the dialog input.

### CROSS-REFERENCE TO RELATED APPLICATION

The present disclosure claims the priority and benefit of Chinese Patent Application No. 202310797318.6, filed on Jun. 30, 2023, entitled “GENERATIVE DIALOG MODEL TRAINING METHOD AND APPARATUS AS WELL AS GENERATIVE DIALOG IMPLEMENTING METHOD AND APPARATUS”. The disclosure of the above application is incorporated herein by reference in its entirety.

### TECHNICAL FIELD

The present disclosure relates to the field of artificial intelligence technologies, particularly to the fields of deep learning, natural language processing, intelligent dialog or the like, and more particularly to a generative dialog model training method and apparatus as well as a generative dialog implementing method and apparatus.

### BACKGROUND

A generative dialog system is a method for directly generating a reply according to a dialog input by using a deep learning technology. With a development of an artificial intelligence technology, the generative dialog system is widely applied in different scenarios as a novel natural language processing task. However, in practical applications, the generative dialog system also faces some challenges and risks, such as an output safety problem.

### SUMMARY

The present disclosure provides a generative dialog model training method and apparatus as well as a generative dialog implementing method and apparatus.

A generative dialog model training method includes:
in response to determination of an update of a safety specification, taking an updated safety specification as a target safety specification, and determining a dialog input corresponding to current optimization according to the target safety specification, the update being performed on a previous safety specification when a generative dialog model after last optimization is determined not to meet a launch requirement; and
optimizing the generative dialog model according to the dialog input and a principle that a reply generated by the generative dialog model conforms to the target safety specification, the generative dialog model being configured to generate the reply corresponding to the dialog input.

A generative dialog implementing method includes:
obtaining a to-be-processed dialog input; and
generating a reply corresponding to the to-be-processed dialog input by using a generative dialog model, the generative dialog model being obtained after N optimization iterations and conforming to a launch requirement, N being a positive integer greater than one, and each optimization iteration including optimization performed on the generative dialog model according to a determined dialog input and a principle that a reply generated by the generative dialog model conforms to a target safety specification in response to determination of an update of a safety specification, the target safety specification being an updated safety specification, the determined dialog input corresponding to a current optimization determined according to the target safety specification, and the update being performed on a previous safety specification when the generative dialog model after last optimization is determined not to meet the launch requirement.

An electronic device includes:
at least one processor; and
a memory connected with the at least one processor communicatively;
where the memory stores instructions executable by the at least one processor to enable the at least one processor to perform the method as mentioned above.

There is provided a non-transitory computer readable storage medium with computer instructions stored thereon, where the computer instructions are used for causing a computer to perform the method as mentioned above.

It should be understood that the statements in this section are not intended to identify key or critical features of the embodiments of the present disclosure, nor limit the scope of the present disclosure. Other features of the present disclosure will become apparent from the following description.

### BRIEF DESCRIPTION OF THE DRAWINGS

The drawings are used for better understanding the present solution and do not constitute a limitation of the present disclosure. In the drawings,

FIG. 1 is a flow chart of a generative dialog model training method according to an embodiment of the present disclosure;

FIG. 2 is a schematic diagram of training and working manners of an existing generative dialog model;

FIG. 3 is a schematic diagram of an iterative optimization manner for a safety specification and a safety system in the present disclosure;

FIG. 4 is a schematic diagram of a relationship between a baseline model and a target model in the present disclosure;

FIG. 5 is a schematic diagram of an overall optimization manner of the safety system in the present disclosure;

FIG. 6 is a flow chart of a generative dialog implementing method according to an embodiment of the present disclosure;

FIG. 7 is a schematic structural diagram of a generative dialog model training apparatus 700 according to an embodiment of the present disclosure;

FIG. 8 is a schematic structural diagram of a generative dialog implementing apparatus 800 according to the present disclosure; and

FIG. 9 shows a schematic block diagram of an electronic device 900 which may be configured to implement the embodiment of the present disclosure.

### DETAILED DESCRIPTION OF EMBODIMENTS

The following part will illustrate exemplary embodiments of the present disclosure with reference to the drawings, including various details of the embodiments of the present disclosure for a better understanding. The embodiments should be regarded only as exemplary ones. Therefore, those skilled in the art should appreciate that various changes or modifications can be made with respect to the embodiments described herein without departing from the scope and spirit of the present disclosure. Similarly, for clarity and conciseness, the descriptions of the known functions and structures are omitted in the descriptions below.

In addition, it should be understood that the term “and/or” only describes an association relationship between associated objects, and indicates that three relationships may exist. For example, A and/or B may indicate three cases: only A exists; both A and B exist; and only B exists. In addition, in this specification, the symbol “/” generally indicates that associated objects have a relationship of “or”.

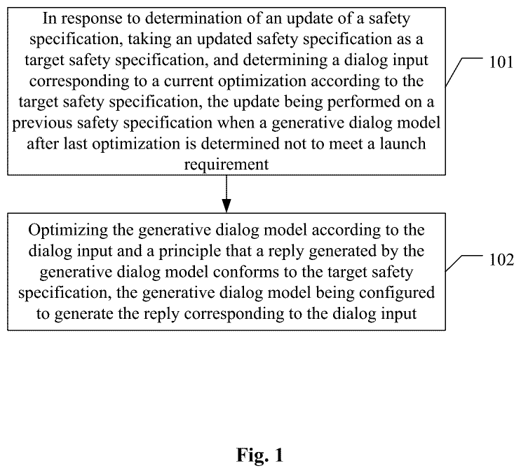

FIG. 1 is a flow chart of a generative dialog model training method according to an embodiment of the present disclosure. As shown in FIG. 1, the method includes the following implementation steps:

Step 101: in response to determination of an update of a safety specification, taking an updated safety specification as a target safety specification, and determining a dialog input (query) corresponding to a current optimization according to the target safety specification, the update being performed on a previous safety specification when a generative dialog model after last optimization is determined not to meet a launch requirement.

Step 102: optimizing the generative dialog model according to the dialog input and a principle that a reply generated by the generative dialog model conforms to the target safety specification, the generative dialog model being configured to generate the reply corresponding to the dialog input.

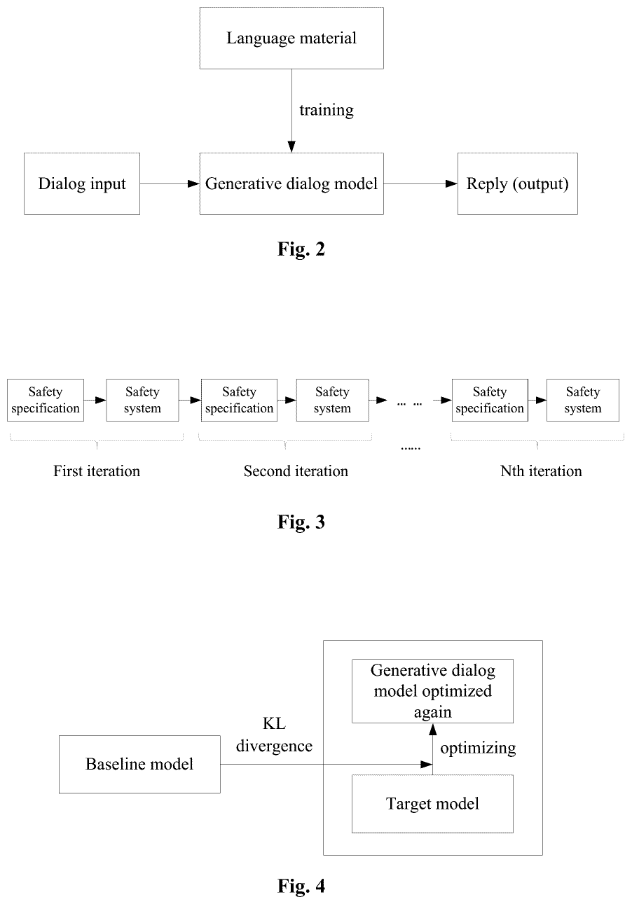

A generative dialog system generates the reply based on a deep learning model, i.e., the generative dialog model, and the generative dialog model is usually obtained by learning language rules and knowledge from a large number of training samples (language materials). As shown in FIG. 2, FIG. 2 is a schematic diagram of training and working manners of an existing generative dialog model. Correspondingly, the generative dialog model can be affected by noise, bias, errors, or the like, present in the language material, resulting in inappropriate or harmful replies which may compromise feelings, trust, or interests of users, and may even cause legal or moral responsibility. Therefore, an improvement of output safety of the generative dialog model is an urgent problem to be solved.

In practical applications, the generative dialog model no longer faces content-limited and single-form dialog inputs, but is required to simultaneously face various possible task forms, such as chatting, information questioning and answering, text translation, text creation, code creation, or the like, such that the input and output of the model can have any text form, a safety solution of the model is also required to simultaneously consider various possible situations, and an ideal state is difficult to achieve at a time.

Correspondingly, the solution of the method embodiment provides a progressively-iterative generative dialog model optimization manner, continuous optimization is performed through alternate iterations of two parts, i.e., the safety specification and the generative dialog model, the output safety of the generative dialog model is continuously improved, and finally, the reply generated by the generative dialog model can be aligned with a safety value of a human.

The safety specification has a goal of defining a standard conforming to the safety value of the human, and the specification has a core function of answering a safe reply.

For example, the safety specification may include an evaluation specification of at least one evaluation dimension corresponding to different combinations respectively, any combination consists of a content field and an application scenario, the content field is a safe content field involved by a generative dialog, and the application scenario is an application scenario of the generative dialog.

For example, the content field may include politics, laws, pornography, morality, values, or the like, and the application scenario may include chatting, information questioning and answering, text translation, text creation, code creation, or the like. The same content field has different safety standards in different application scenarios, such that the content field and the application scenario are required to be combined to refine the safety specification.

One content field and one application scenario may form one combination, and correspondingly, assuming that there are 3 (the number is merely illustrative) content fields: content field 1, content field 2 and content field 3, and assuming that there are 3 application scenarios: application scenario 1, application scenario 2 and application scenario 3, the following combinations may be obtained: content field 1+application scenario 1, content field 1+application scenario 2, content field 1+application scenario 3, content field 2+application scenario 1, content field 2+application scenario 2, content field 2+application scenario 3, content field 3+application scenario 1, content field 3+application scenario 2, and content field 3+application scenario 3.

Each combination may correspond to the evaluation specifications of one or more evaluation dimensions, such as 1 evaluation dimension, i.e., safety, or 3 evaluation dimensions, i.e., safety, knowledge accuracy and content richness, and regardless of the number of the corresponding evaluation dimensions, in general, the evaluation dimension of safety must exist, that is, is most basic, and other evaluation dimensions are further optimization on this basis.

For each combination, different evaluation dimensions may correspond to different evaluation specifications respectively; for example, for the combination of content field 1+application scenario 1, assuming that there are 2 evaluation dimensions which are safety and knowledge accuracy respectively, the two evaluation dimensions correspond to different evaluation specifications, i.e., the evaluation specification required to be satisfied when evaluation indicates safety and the evaluation specification required to be satisfied when the evaluation indicates accurate knowledge.

It can be seen that, using the processing mode, corresponding evaluation specifications can be formulated according to different content fields, different application scenarios and different evaluation dimensions respectively, thereby improving accuracy of subsequent processing results.

The safety specification and the safety system are iterated alternately to be continuously optimized, and the safety system may include the generative dialog model and a detection model which may be optimized under a direction of the safety specification.

FIG. 3 is a schematic diagram of an iterative optimization manner for the safety specification and the safety system in the present disclosure. As shown in FIG. 3, in an initial stage, an expert may determine one safety specification according to experience, and then perform optimization of the safety system based on the safety specification, and after the optimization of the safety system, the expert may evaluate whether the generative dialog model therein meets the launch requirement, and if no, the safety specification may be updated according to safety defects (exposed safety problems), or the like, of the safety system evaluated by the expert; for example, the expert may perform a simulation attack on the safety system to determine the safety defects, and after the update of the safety specification, optimization of the safety system may be performed again based on the updated safety specification, and the process may be repeated continuously.

For example, the update of the safety specification may include one or any combination of: addition of a combination and an evaluation specification of at least one corresponding evaluation dimension, addition of an evaluation dimension and a corresponding evaluation specification for a previous combination, and adjustment of the previous evaluation specification. That is, the combination and the evaluation specification of the at least one corresponding evaluation dimension can be added into the safety specification, or one or more evaluation dimensions and the corresponding evaluation specifications can be added to one previous combination or some previous combinations, or the previous evaluation specification can be adjusted (such as refined), and quite flexible and convenient effects are achieved.

For convenience of description, an updated safety specification is referred to as a target safety specification, and the dialog input corresponding to the current optimization (i.e., the optimization to be performed on the safety system) may be determined according to the target safety specification.

For example, a first dialog input set may be obtained, dialog inputs therein are taken as the dialog inputs corresponding to the current optimization, the first dialog input set at least includes the dialog inputs corresponding to the updated combination, and the first dialog input set meets the following predetermined condition: a number proportion of first-class dialog inputs is larger than that of second-class dialog inputs, the first-class dialog inputs are the dialog inputs corresponding to the updated combination, and the second-class dialog inputs are the dialog inputs corresponding to the combination without the update.

For example, assuming that the safety specification includes 9 combinations which are combination 1 to combination 9 respectively, and combination 1 and combination 2 are updated, the first dialog input set may include more dialog inputs corresponding to combination 1 and combination 2, and include a relatively small number of dialog inputs corresponding to other combinations, or may not include the dialog inputs corresponding to other combinations directly. For example, assuming that combination 1 is a law+information questioning and answering, the corresponding dialog input may be question information related to the law.

With the processing, emphasis optimization of the updated content in the safety specification can be realized, thereby improving an optimization effect, and improving an optimization efficiency.

The dialog inputs in the first dialog input set may be: selected from user utterances of publicly deployed dialog product services, given by experts according to the safety specification, or automatically generated by the model, and a specific mode is not limited.

According to the dialog inputs in the first dialog input set, the safety system may be optimized in accordance with the principle that the reply generated by the generative dialog model conforms to the target safety specification.

For example, some or all of the dialog inputs may be selected from the first dialog input set to form a second dialog input set, the second dialog input set meets the predetermined condition, replies corresponding to the dialog inputs in the second dialog input set are generated by the generative dialog model to form a first reply set, the generative dialog model and the detection model are optimized according to the first reply set and the target safety specification, some or all of the dialog inputs are selected from the first dialog input set to form a third dialog input set, the third dialog input set meets the predetermined condition, replies corresponding to the dialog inputs in the third dialog input set are generated by the optimized generative dialog model to form a second reply set, the optimized generative dialog model is optimized again according to the second reply set and the optimized detection model, and the detection model is configured to carry out safety detection on the generated replies.

The safety system includes the generative dialog model and a detection model, and an ultimate aim is to improve the output safety of the generative dialog model whether the generative dialog model or the detection model is optimized.

The generative dialog model may be a model obtained by pre-training, for example, a large-scale language model based on Transformer, which is obtained by performing training based on massive training samples and contains rich knowledge, but the generated reply has a safety risk, the model can be actually launched and deployed after aligned with the safety value of the human, and correspondingly, the generative dialog model after pre-training may be optimized according to the manner according to the present disclosure.

The detection model may be configured to perform safety detection on the reply generated by the generative dialog model, so as to judge whether there is a safety risk, or the like.

It can be seen that the optimization manner is a two-stage optimization manner; in a first stage, the generative dialog model and the detection model are optimized to obtain the optimized generative dialog model and the optimized detection model; in a second stage, the optimized generative dialog model is optimized again by means of the optimized detection model; that is, in the process of one optimization iteration, the generative dialog model can be optimized two times, and different implementations are adopted for the two times of optimization, thereby further improving the optimization effect, or the like.

Specific implementation of the first stage and the second stage is described in detail below.

### 1) First Stage

Some or all of the dialog inputs may be selected from the first dialog input set to form the second dialog input set, and the second dialog input set is required to meet the predetermined condition: the number proportion of the first-class dialog inputs is greater than that of the second-class dialog inputs. Since the following process involves manual annotation, in order to reduce a workload, or the like, only some of the dialog inputs in the first dialog input set are usually included in the second dialog input set, and a specific number is not limited.

Then, the replies corresponding to the dialog inputs in the second dialog input set may be generated by the generative dialog model to form the first reply set, and for example, the first reply set may include M replies generated for each dialog input in the second dialog input set, M is a positive integer greater than one, and a specific value of M may be determined according to actual needs; that is, multiple replies may be generated for each dialog input in the second dialog input set.

Further, the generative dialog model and the detection model may be optimized according to the first reply set and the target safety specification. For example, the following processing can be performed on any dialog input in the second dialog input set: taking the dialog input as the to-be-processed dialog input, and acquiring each candidate reply corresponding to the to-be-processed dialog input and an manual annotation result of each candidate reply, a number of the candidate replies being greater than or equal to M, the candidate replies including the replies generated for the to-be-processed dialog input and/or replies obtained by manually modifying the replies generated for the to-be-processed dialog input, and the manual annotation result of each candidate reply including an annotation result obtained after safety annotation is manually performed on the candidate reply according to the target safety specification; constructing a training sample according to the to-be-processed dialog input, each candidate reply and the manual annotation result of each candidate reply, and optimizing the generative dialog model and the detection model by using the training sample.

In addition, for example, for any one candidate reply, the annotation result after safety annotation may include evaluation labels of the candidate reply corresponding to different evaluation dimensions manually annotated according to the evaluation specifications of different evaluation dimensions of the combination corresponding to the to-be-processed dialog input, and the evaluation label indicates conformance to the corresponding evaluation specification (yes) or non-conformance to the corresponding evaluation specification (no).

Each dialog input in the second dialog input set may be taken as the to-be-processed dialog input and processed in the same manner. Specifically, assuming that 6 replies which are reply 1 to reply 6 respectively are generated for one to-be-processed dialog input, a plurality of candidate replies can be generated according to the 6 replies, the specific number is not limited, for example, 6 or more, and generally, the candidate replies are required to include replies of various safety statuses as much as possible, for example, replies with all the evaluation labels of the evaluation dimensions indicating conformance to the corresponding evaluation specification, replies with some evaluation labels indicating conformance to the corresponding evaluation specification and the rest evaluation labels indicating non-conformance to the corresponding evaluation specification, replies with all the evaluation labels of the evaluation dimensions indicating non-conformance to the corresponding evaluation specification, or the like; in addition, some or all of the 6 replies can be directly used as the candidate replies, or some or all of the 6 replies may be modified to a certain extent to obtain the replies of the required safety statuses.

The above process may be referred to as a safety data annotation process having a purpose of providing data support for the generative dialog model and the detection model, so as to optimize the generative dialog model and the detection model.

For example, first-class training samples and second-class training samples can be constructed, the generative dialog model can be optimized by the first-class training samples in a supervised learning mode, and the detection model can be optimized by the second-class training samples in a supervised learning mode.

That is, targeted training sample construction modes can be adopted for the generative dialog model and the detection model respectively, and model optimization is correspondingly carried out, thereby improving the model optimization effect.

For example, a way of constructing the first-class training samples may include: selecting candidate replies meeting the following condition from the candidate replies: the evaluation labels of different evaluation dimensions all indicate conformance to the corresponding evaluation specification; and forming the first-class training samples by the selected candidate replies and the to-be-processed dialog input.

For example, assuming that the number of the candidate replies is 12, and 2 of the candidate replies satisfy the condition that the evaluation labels of different evaluation dimensions all indicate conformance to the corresponding evaluation specification, the candidate replies and the to-be-processed dialog input can form the training samples to obtain 2 training samples.

For the dialog inputs in the second dialog input set, training samples, i.e., the first-class training samples, may be generated in the above manner, and then, the generative dialog model may be optimized using the generated first-class training samples. Specifically, the generative dialog model can score the candidate replies in the first-class training samples, negative log-likelihood loss is calculated using the scores, and then, the loss is minimized by adopting a gradient descent method, such that the generative dialog model is more prone to generating the corresponding candidate replies in the first-class training samples for the dialog input in the first-class training samples, and then, the purpose of model optimization is achieved.

In addition, for the to-be-processed dialog input, a comprehensive score of each candidate reply can be obtained, the higher the comprehensive score is, the higher the safety is, the detection models can include a comprehensive detection model and classification detection models corresponding to different evaluation dimensions respectively, the second-class training sample may include a first-sub-class training sample and a second-sub-class training sample, the first-sub-class training sample may include two candidate replies with different comprehensive scores, the to-be-processed dialog input, and a sample label, the sample label is used to indicate the candidate reply with a higher comprehensive score in the two candidate replies, the second-sub-class training sample may include one candidate reply, the to-be-processed dialog input and an evaluation label for the candidate reply, and correspondingly, the optimization of the detection models may include: optimizing the comprehensive detection model by using the first-sub-class training sample, and for any classification detection model, optimizing the classification detection model by using the second-sub-class training sample including the evaluation label of the evaluation dimension corresponding to the classification detection model. The comprehensive detection model and each classification detection model can be Transformer-based models.

For example, assuming that 12 candidate replies exist, and each candidate reply corresponds to 3 evaluation labels, the comprehensive score of each candidate reply can be determined according to the 3 evaluation labels; as a possible implementation, different weights can be set for different evaluation labels respectively; for example, the weight corresponding to the evaluation dimension of safety is highest, and the weights of other evaluation dimensions are all lower than that of the evaluation dimension; in addition, if the evaluation label is yes (conformance to the corresponding evaluation specification), a value can be 1, otherwise, the value can be 0, and correspondingly, for any candidate reply, the comprehensive score of the candidate reply can be calculated according to the values of the 3 evaluation labels and the corresponding weights.

In order to better optimize the generative dialog model and make the generative dialog model more prone to generating safe replies, the number of the detection models can be multiple; that is, the detection models can include one comprehensive detection model and the classification detection models corresponding to different evaluation dimensions respectively, such that judgment signals can be given from the aspects of overall safety, different evaluation dimensions, or the like, for optimization of the generative dialog model, and the optimization effect, or the like, are correspondingly improved.

In addition, it can be seen that in the above processing manner, targeted optimization manners may be adopted for the comprehensive detection model and the classification detection models respectively, thereby further improving the optimization effect, or the like.

For the comprehensive detection model, the first-sub-class training sample can be constructed and can include the two candidate replies with different comprehensive scores, the to-be-processed dialog input and the sample label, and the sample label is used for indicating the candidate reply with the higher comprehensive score in the two candidate replies.

For example, assuming that there are 12 candidate replies, the candidate replies may be combined in pairs to construct a plurality of first-sub-class training samples, and each of the first-sub-class training samples may include two candidate replies with different comprehensive scores, the to-be-processed dialog input, and a sample label for indicating the candidate reply with a higher comprehensive score in the two candidate replies.

For each dialog input in the second dialog input set, the first-sub-class training sample can be constructed in the above manner, and then, the comprehensive detection model can be optimized by using the constructed first-sub-class training sample, and the negative log-likelihood loss and the gradient descent method can also be adopted in the optimization, such that the comprehensive detection model learns a way of distinguishing quality of different candidate replies, or the like.

Each second-sub-class training sample may include one candidate reply, the to-be-processed dialog input, and one evaluation label for the candidate reply.

In addition, for each dialog input in the second dialog input set, the second-sub-class training sample may be constructed in the above manner.

Correspondingly, the classification detection models corresponding to different evaluation dimensions can be optimized by using the second-sub-class training samples. For example, assuming that there are evaluation dimension 1, evaluation dimension 2, and evaluation dimension 3, the classification detection model corresponding to the evaluation dimension 1 may be optimized using the second-sub-class training sample including the evaluation label corresponding to the evaluation dimension 1, the classification detection model corresponding to the evaluation dimension 2 may be optimized using the second-sub-class training sample including the evaluation label corresponding to the evaluation dimension 2, and the classification detection model corresponding to the evaluation dimension 3 may be optimized using the second-sub-class training sample including the evaluation label corresponding to the evaluation dimension 3.

### 2) Second Stage

After the optimization of the first stage is completed, optimization of the second stage can be performed; that is, the optimized generative dialog model can be optimized again by means of the optimized detection model.

First, some or all of the dialog inputs may be selected from the first dialog input set to form the third dialog input set, and the third dialog input set is required to meet the predetermined condition: the number proportion of the first-class dialog inputs is greater than that of the second-class dialog inputs. To improve the optimization effect, all of the dialog inputs of the first dialog input set may be included in the third dialog input set.

Then, the replies corresponding to the dialog inputs in the third dialog input set may be generated by using the optimized generative dialog model to form the second reply set. For example, the second reply set may include the replies generated for the dialog inputs in the third dialog input set respectively.

Further, the optimized generative dialog model may be optimized again according to the second reply set and the optimized detection model. For example, safety detection may be performed on each reply in the second reply set by the optimized detection model, and the optimized generative dialog model may be optimized again in a reinforcement learning manner according to a safety detection result of each reply. An adopted reinforcement learning algorithm may be a proximal policy optimization (PPO) algorithm, or the like.

That is, the detection model may be adopted as a referee to optimize the optimized generative dialog model again, so as to further improve the optimization effect of the generative dialog model.

For example, the detection model may include the comprehensive detection model and the classification detection models corresponding to different evaluation dimensions respectively, and correspondingly, the following processing may be performed for any one reply in the second reply set: obtaining a comprehensive detection result of the reply and classification detection results corresponding to different classification detection models respectively, determining a reward corresponding to the reply by combining the comprehensive detection result and the different classification detection results, forming a training sample by using the reply, the dialog input corresponding to the reply and the reward, and similarly, constructing the training sample in this manner for each reply in the second reply set, and then optimizing the optimized generative dialog model again by using the constructed training samples.

For example, for reply a, the comprehensive detection result (which may be in a score form) and the classification detection results corresponding to different evaluation dimensions are obtained, and then, the comprehensive detection result and the different classification detection results may be fused by adopting a predetermined fusion algorithm, so as to determine the reward corresponding to the reply a, and a specific form of the fusion algorithm may be determined according to actual needs.

Correspondingly, one training sample can be formed by the reply a, the dialog input corresponding to the reply a, and the reward corresponding to the reply a, and similarly, training samples corresponding to the other replies can be obtained, and then, the optimized generative dialog model can be optimized again by using each training sample.

In addition, for example, the optimized generative dialog model may be used as a baseline model, a target model identical to the baseline model may be generated, and then, the target model may be optimized using the training sample based on a constraint of a Kullback-Leibler (KL) divergence introduced between the baseline model and the target model, and the optimized target model may be used as the generative dialog model optimized again.

That is, it may be understood to maintain two generative dialog models: the optimized generative dialog model (i.e., the baseline model) and the target model. FIG. is a schematic diagram of a relationship between the baseline model and the target model in the present disclosure. As shown in FIG. 4, the baseline model may be considered to remain unchanged in the re-optimization process, the target model is identical to the baseline model before the target model is optimized, and when the target model is optimized by using the training sample, since the optimization process is difficult and the model tends to generate messy codes and other extreme conditions, a KL divergence between the baseline model and the target model may be additionally introduced for the constraint, such that the target model does not deviate too far from the baseline model, and in addition, the optimized target model may be used as the required re-optimized generative dialog model.

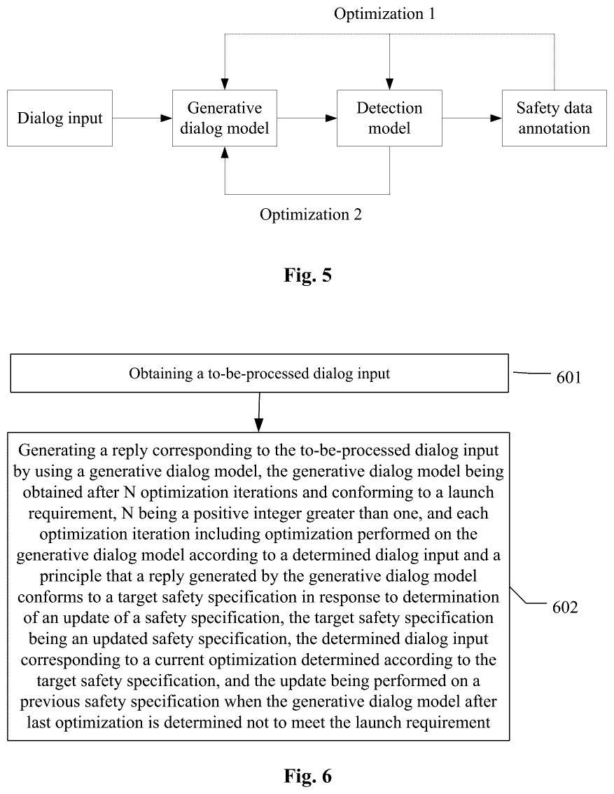

In conjunction with the above description, FIG. 5 is a schematic diagram of an overall optimization manner of the safety system in the present disclosure. As shown in FIG. 5, optimization 1 indicates a process of optimizing the generative dialog model and the detection model, optimization 2 indicates a process of optimizing the optimized generative dialog model again by means of the optimized detection model, and during optimization 1, the reply output by the generative dialog model may pass through the detection model or may be directly annotated manually without passing through the detection model.

After the safety system is optimized in the manner shown in FIG. 5 each time, the expert can reevaluate whether the newly obtained generative dialog model meets the launch requirement, and if no, the safety specification can be updated, the safety system can be optimized again based on the updated safety specification, and if yes, the newly obtained generative dialog model can be actually deployed and launched, and in addition, after the actual deployment and launch, if necessary, the generative dialog model can be continuously optimized in the manner disclosed in the present disclosure.

Correspondingly, FIG. 6 is a flow chart of a generative dialog implementing method according to an embodiment of the present disclosure. As shown in FIG. 6, the method includes the following implementation steps:

step 601: obtaining a to-be-processed dialog input.

Step 602: generating a reply corresponding to the to-be-processed dialog input by using a generative dialog model, the generative dialog model being obtained after N optimization iterations and conforming to a launch requirement, N being a positive integer greater than one, and each optimization iteration including optimization performed on the generative dialog model according to a determined dialog input and a principle that a reply generated by the generative dialog model conforms to a target safety specification in response to determination of an update of a safety specification, the target safety specification being the updated safety specification, the determined dialog input corresponding to a current optimization determined according to the target safety specification, and the update being performed on a previous safety specification when the generative dialog model after last optimization is determined not to meet the launch requirement.

It can be seen that, with the solution of the method embodiment, continuous optimization may be performed through alternate iterations of two parts, i.e., the safety specification and the generative dialog model, the output safety of the generative dialog model is continuously improved, and correspondingly, the reply is generated by using the trained generative dialog model, such that safety of the generated reply can be improved.

The generative dialog model may be a generative dialog model meeting the launch requirement obtained by the method corresponding to the embodiment shown in FIG. 1.

It should be noted that for simplicity of description, all the above-mentioned embodiments of the method are described as combinations of a series of acts, but those skilled in the art should understand that the present disclosure is not limited by the described order of acts, as some steps may be performed in other orders or simultaneously according to the present disclosure. Further, those skilled in the art should also understand that the embodiments described in this specification are preferred embodiments and that acts and modules referred to are not necessary for the present disclosure. In addition, for parts that are not described in detail in a certain embodiment, reference may be made to the related descriptions of other embodiments.

The above is a description of an embodiment of the method, and an embodiment of an apparatus according to the present disclosure will be further described below.

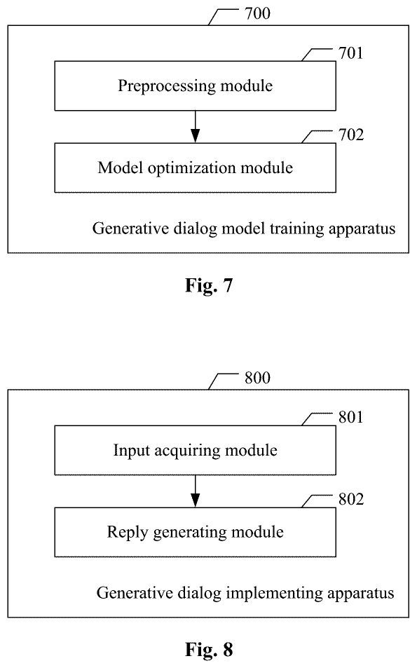

FIG. 7 is a schematic structural diagram of a generative dialog model training apparatus 700 according to an embodiment of the present disclosure. As shown in FIG. 7, the apparatus includes:
a preprocessing module 701 configured to, in response to determination of an update of a safety specification, take an updated safety specification as a target safety specification, and determine a dialog input corresponding to current optimization according to the target safety specification, the update being performed on the previous safety specification when a generative dialog model after last optimization is determined not to meet a launch requirement; and
a model optimizing module 702 configured to optimize the generative dialog model according to the dialog input and a principle that a reply generated by the generative dialog model conforms to the target safety specification, the generative dialog model being configured to generate the reply corresponding to the dialog input.

The solution of the apparatus embodiment adopts a progressively-iterative generative dialog model optimization manner, continuous optimization is performed through alternate iterations of two parts, i.e., the safety specification and the generative dialog model, the output safety of the generative dialog model is continuously improved, and finally, the reply generated by the generative dialog model can be aligned with a safety value of a human.

For example, the safety specification may include an evaluation specification of at least one evaluation dimension corresponding to different combinations respectively, any combination consists of a content field and an application scenario, the content field is a safe content field involved by a generative dialog, and the application scenario is an application scenario of the generative dialog; correspondingly, the update of the safety specification may include one or any combination of: addition of a combination and an evaluation specification of at least one corresponding evaluation dimension, addition of an evaluation dimension and a corresponding evaluation specification for the previous combination, and adjustment of the previous evaluation specification.

For example, the preprocessing module 701 may obtain a first dialog input set, and take dialog inputs therein as the dialog inputs corresponding to the current optimization, the first dialog input set at least includes the dialog inputs corresponding to an updated combination, and the first dialog input set meets the following predetermined condition: a number proportion of first-class dialog inputs is larger than that of second-class dialog inputs, the first-class dialog inputs are the dialog inputs corresponding to the updated combination, and the second-class dialog inputs are the dialog inputs corresponding to the combination without the update.

The dialog inputs in the first dialog input set may be: selected from user utterances of publicly deployed dialog product services, given by experts according to the safety specification, or automatically generated by the model.

For example, the model optimizing module 702 may select some or all of the dialog inputs from the first dialog input set to form a second dialog input set, the second dialog input set meeting the predetermined condition, generate replies corresponding to the dialog inputs in the second dialog input set by the generative dialog model to form a first reply set, optimize the generative dialog model and the detection model according to the first reply set and the target safety specification, select some or all of the dialog inputs from the first dialog input set to form a third dialog input set, the third dialog input set meeting the predetermined condition, generate replies corresponding to the dialog inputs in the third dialog input set by the optimized generative dialog model to form a second reply set, and optimize the optimized generative dialog model again according to the second reply set and the optimized detection model, and the detection model is configured to carry out safety detection on the generated replies.

That is, a two-stage optimization manner may be adopted; in a first stage, the generative dialog model and the detection model are optimized to obtain the optimized generative dialog model and the optimized detection model; in a second stage, the optimized generative dialog model is optimized again by means of the optimized detection model.

For example, the first reply set may include M replies generated for each dialog input in the second dialog input set, and M is a positive integer greater than one; the model optimizing module 702 may perform the following processing on any dialog input in the second dialog input set: taking the dialog input as the to-be-processed dialog input, and acquiring each candidate reply corresponding to the to-be-processed dialog input and an manual annotation result of each candidate reply, a number of the candidate replies being greater than or equal to M, the candidate replies including the replies generated for the to-be-processed dialog input and/or replies obtained by manually modifying the replies generated for the to-be-processed dialog input, and the manual annotation result of each candidate reply including an annotation result obtained after safety annotation is manually performed on the candidate reply according to the target safety specification; constructing a training sample according to the to-be-processed dialog input, each candidate reply and the manual annotation result of each candidate reply, and optimizing the generative dialog model and the detection model by using the training sample.

In addition, for example, for any one candidate reply, the annotation result after safety annotation may include evaluation labels of the candidate reply corresponding to different evaluation dimensions manually annotated according to the evaluation specifications of different evaluation dimensions of the combination corresponding to the to-be-processed dialog input, and the evaluation label indicates conformance to the corresponding evaluation specification or non-conformance to the corresponding evaluation specification.

For example, the model optimizing module 702 may construct first-class training samples and second-class training samples, optimize the generative dialog model by the first-class training samples in a supervised learning mode, and optimize the detection model by the second-class training samples in a supervised learning mode.

For example, a way of constructing the first-class training samples by the model optimizing module 702 may include: selecting candidate replies meeting the following condition from the candidate replies: the evaluation labels of different evaluation dimensions all indicate conformance to the corresponding evaluation specification; and forming the first-class training samples by the selected candidate replies and the to-be-processed dialog input.

For the dialog inputs in the second dialog input set, training samples, i.e., the first-class training samples, may be generated in the above manner, and then, the generative dialog model may be optimized using the generated first-class training samples.

For example, the model optimizing module 702 may further obtain a comprehensive score of each candidate reply, the higher the comprehensive score is, the higher the safety is, the detection models can include a comprehensive detection model and classification detection models corresponding to different evaluation dimensions respectively, the second-class training sample may include a first-sub-class training sample and a second-sub-class training sample, the first-sub-class training sample may include two candidate replies with different comprehensive scores, the to-be-processed dialog input, and a sample label, the sample label is used to indicate the candidate reply with a higher comprehensive score in the two candidate replies, the second-sub-class training sample may include one candidate reply, the to-be-processed dialog input and an evaluation label for the candidate reply, and correspondingly, the optimization of the detection models may include: optimizing the comprehensive detection model by using the first-sub-class training sample, and for any classification detection model, optimizing the classification detection model by using the second-sub-class training sample including the evaluation label of the evaluation dimension corresponding to the classification detection model.

In addition, for example, the second reply set may include the replies generated for the dialog inputs in the third dialog input set respectively; the model optimizing module 702 may perform safety detection on each reply in the second reply set by the optimized detection model, and optimize the optimized generative dialog model again in a reinforcement learning manner according to a safety detection result of each reply.

For example, the detection models may include the comprehensive detection model and the classification detection models corresponding to different evaluation dimensions respectively, and correspondingly, the model optimizing module 702 may perform the following processing for any reply: obtaining a comprehensive detection result of the reply and classification detection results corresponding to different classification detection models respectively, determining a reward corresponding to the reply by combining the comprehensive detection result and the different classification detection results, forming a training sample by using the reply, the dialog input corresponding to the reply and the reward, and similarly, constructing the training sample in this manner for each reply in the second reply set, and then optimizing the optimized generative dialog model again by using the constructed training samples.

For example, the model optimizing module 702 may use the optimized generative dialog model as a baseline model, generate a target model identical to the baseline model, optimize the target model using the training sample based on a constraint of a KL divergence introduced between the baseline model and the target model, and use the optimized target model as the generative dialog model optimized again.

FIG. 8 is a schematic structural diagram of a generative dialog implementing apparatus 800 according to the present disclosure. As shown in FIG. 8, the apparatus includes:
an input acquiring module 801 configured to obtain a to-be-processed dialog input; and
a reply generating module 802 configured to generate a reply corresponding to the to-be-processed dialog input by using a generative dialog model, the generative dialog model being obtained after N optimization iterations and conforming to a launch requirement, N being a positive integer greater than one, and each optimization iteration including optimization performed on the generative dialog model according to a determined dialog input and a principle that a reply generated by the generative dialog model conforms to a target safety specification in response to determination of an update of a safety specification, the target safety specification being an updated safety specification, the determined dialog input corresponding to a current optimization determined according to the target safety specification, and the update being performed on a previous safety specification when the generative dialog model after last optimization is determined not to meet the launch requirement.

It can be seen that, by adopting the solution of the apparatus embodiment, continuous optimization may be performed through alternate iterations of two parts, i.e., the safety specification and the generative dialog model, the output safety of the generative dialog model is continuously improved, and correspondingly, the reply is generated by using the trained generative dialog model, such that safety of the generated reply can be improved.

For the specific work flow of the embodiments of the apparatuses shown in FIGS. 7 and 8, reference may be made to the related description in the foregoing embodiment of the method, and details are not repeated.

In a word, the solution of the present disclosure provides a multi-dimensional progressively iterative generative dialog model safety solution, which can improve the output safety of the generative dialog model, is applicable to various application scenarios, content fields, or the like, and has wide applicability.

The solution of the present disclosure may be applied to the field of artificial intelligence, and particularly relates to the fields of deep learning, natural language processing, intelligent dialogs, or the like. Artificial intelligence is a subject of researching how to cause a computer to simulate certain thought processes and intelligent behaviors (for example, learning, inferring, thinking, planning, or the like) of a human, and includes both hardware-level technologies and software-level technologies. Generally, the hardware technologies of the artificial intelligence include technologies, such as a sensor, a dedicated artificial intelligence chip, cloud computing, distributed storage, big data processing, or the like; the software technologies of the artificial intelligence mainly include a computer vision technology, a voice recognition technology, a natural language processing technology, a machine learning/deep learning technology, a big data processing technology, a knowledge graph technology, or the like.

The dialog input, the reply, or the like, in the embodiments of the present disclosure are not specific to a specific user, and cannot reflect personal information of a specific user. In the technical solution of the present disclosure, the collection, storage, usage, processing, transmission, provision, disclosure, or the like, of involved user personal information are in compliance with relevant laws and regulations, and do not violate public order and good customs.

According to the embodiment of the present disclosure, there are also provided an electronic device, a readable storage medium and a computer program product.

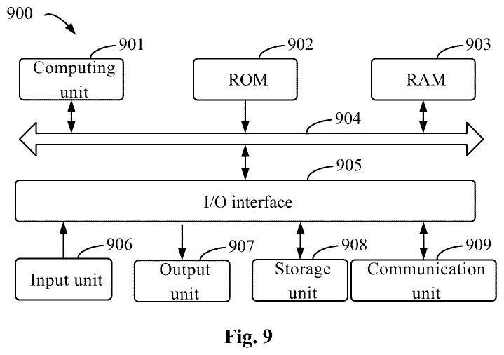

FIG. 9 shows a schematic block diagram of an electronic device 900 which may be configured to implement the embodiment of the present disclosure. The electronic device is intended to represent various forms of digital computers, such as laptop computers, desktop computers, workstations, servers, blade servers, mainframe computers, and other appropriate computers. The electronic device may also represent various forms of mobile apparatuses, such as personal digital assistants, cellular telephones, smart phones, wearable devices, and other similar computing apparatuses. The components shown herein, their connections and relationships, and their functions, are meant to be exemplary only, and are not meant to limit implementation of the present disclosure described and/or claimed herein.

As shown in FIG. 9, the device 900 includes a computing unit 901 which may perform various appropriate actions and processing operations according to a computer program stored in a read only memory (ROM) 902 or a computer program loaded from a storage unit 908 into a random access memory (RAM) 903. Various programs and data necessary for the operation of the device 900 may be also stored in the RAM 903. The computing unit 901, the ROM 902, and the RAM 903 are connected with one other through a bus 904. An input/output (I/O) interface 905 is also connected to the bus 904.

The plural components in the device 900 are connected to the I/O interface 905, and include: an input unit 906, such as a keyboard, a mouse, or the like; an output unit 907, such as various types of displays, speakers, or the like; the storage unit 908, such as a magnetic disk, an optical disk, or the like; and a communication unit 909, such as a network card, a modem, a wireless communication transceiver, or the like. The communication unit 909 allows the device 900 to exchange information/data with other devices through a computer network, such as the Internet, and/or various telecommunication networks.

The computing unit 901 may be a variety of general and/or special purpose processing components with processing and computing capabilities. Some examples of the computing unit 901 include, but are not limited to, a central processing unit (CPU), a graphic processing unit (GPU), various dedicated artificial intelligence (AI) computing chips, various computing units running machine learning model algorithms, a digital signal processor (DSP), and any suitable processor, controller, microcontroller, or the like. The computing unit 901 performs the methods and processing operations described above, such as the method according to the present disclosure. For example, in some embodiments, the method according to the present disclosure may be implemented as a computer software program tangibly contained in a machine readable medium, such as the storage unit 908. In some embodiments, part or all of the computer program may be loaded and/or installed into the device 900 via the ROM 902 and/or the communication unit 909. When the computer program is loaded into the RAM 903 and executed by the computing unit 901, one or more steps of the method according to the present disclosure may be performed. Alternatively, in other embodiments, the computing unit 901 may be configured to perform the method according to the present disclosure by any other suitable means (for example, by means of firmware).

Various implementations of the systems and technologies described herein above may be implemented in digital electronic circuitry, integrated circuitry, field programmable gate arrays (FPGA), application specific integrated circuits (ASIC), application specific standard products (ASSP), systems on chips (SOC), complex programmable logic devices (CPLD), computer hardware, firmware, software, and/or combinations thereof. The systems and technologies may be implemented in one or more computer programs which are executable and/or interpretable on a programmable system including at least one programmable processor, and the programmable processor may be special or general, and may receive data and instructions from, and transmit data and instructions to, a storage system, at least one input apparatus, and at least one output apparatus.

Program codes for implementing the method according to the present disclosure may be written in any combination of one or more programming languages. These program codes may be provided to a processor or a controller of a general purpose computer, a special purpose computer, or other programmable data processing apparatuses, such that the program code, when executed by the processor or the controller, causes functions/operations specified in the flowchart and/or the block diagram to be implemented. The program code may be executed entirely on a machine, partly on a machine, partly on a machine as a stand-alone software package and partly on a remote machine, or entirely on a remote machine or a server.

In the context of the present disclosure, the machine readable medium may be a tangible medium which may contain or store a program for use by or in connection with an instruction execution system, apparatus, or device. The machine readable medium may be a machine readable signal medium or a machine readable storage medium. The machine readable medium may include, but is not limited to, an electronic, magnetic, optical, electromagnetic, infrared, or semiconductor system, apparatus, or device, or any suitable combination of the foregoing. More specific examples of the machine readable storage medium may include an electrical connection based on one or more wires, a portable computer disk, a hard disk, a random access memory (RAM), a read only memory (ROM), an erasable programmable read only memory (EPROM or flash memory), an optical fiber, a portable compact disc read only memory (CD-ROM), an optical storage device, a magnetic storage device, or any suitable combination of the foregoing.

To provide interaction with a user, the systems and technologies described here may be implemented on a computer having: a display apparatus (for example, a cathode ray tube (CRT) or liquid crystal display (LCD) monitor) for displaying information to a user; and a keyboard and a pointing apparatus (for example, a mouse or a trackball) by which a user may provide input for the computer. Other kinds of apparatuses may also be used to provide interaction with a user; for example, feedback provided for a user may be any form of sensory feedback (for example, visual feedback, auditory feedback, or tactile feedback); and input from a user may be received in any form (including acoustic, speech or tactile input).

The systems and technologies described here may be implemented in a computing system (for example, as a data server) which includes a back-end component, or a computing system (for example, an application server) which includes a middleware component, or a computing system (for example, a user computer having a graphical user interface or a web browser through which a user may interact with an implementation of the systems and technologies described here) which includes a front-end component, or a computing system which includes any combination of such back-end, middleware, or front-end components. The components of the system may be interconnected through any form or medium of digital data communication (for example, a communication network). Examples of the communication network include: a local area network (LAN), a wide area network (WAN) and the Internet.

A computer system may include a client and a server. Generally, the client and the server are remote from each other and interact through the communication network. The relationship between the client and the server is generated by virtue of computer programs which run on respective computers and have a client-server relationship to each other. The server may be a cloud server or a server of a distributed system, or a server incorporating a blockchain.

It should be understood that various forms of the flows shown above may be used and reordered, and steps may be added or deleted. For example, the steps described in the present disclosure may be executed in parallel, sequentially, or in different orders, which is not limited herein as long as the desired results of the technical solution disclosed in the present disclosure may be achieved.

The above-mentioned implementations are not intended to limit the scope of the present disclosure. It should be understood by those skilled in the art that various modifications, combinations, sub-combinations and substitutions may be made, depending on design requirements and other factors. Any modification, equivalent substitution and improvement made within the spirit and principle of the present disclosure all should be included in the extent of protection of the present disclosure.

What is claimed is:

1. A generative dialog model training method, comprising:
in response to determination of an update of a safety specification, taking an updated safety specification as a target safety specification, and determining a dialog input corresponding to a current optimization according to the target safety specification, the update being performed on a previous safety specification when a generative dialog model after last optimization is determined not to meet a launch requirement; and
optimizing the generative dialog model according to the dialog input and a principle that a reply generated by the generative dialog model conforms to the target safety specification, the generative dialog model being configured to generate the reply corresponding to the dialog input.

2. The method according to claim 1,
wherein the safety specification comprises an evaluation specification of at least one evaluation dimension corresponding to different combinations respectively, any one combination consists of one content field and one application scenario, the content field is a safe content field involved by a generative dialog, and the application scenario is an application scenario of the generative dialog;
the update of the safety specification comprises one or any combination of: addition of a combination and an evaluation specification of at least one corresponding evaluation dimension, addition of an evaluation dimension and a corresponding evaluation specification for a previous combination, and adjustment of the previous evaluation specification.

3. The method according to claim 2, wherein determining the dialog input corresponding to the current optimization according to the target safety specification comprises:
obtaining a first dialog input set, and taking dialog inputs therein as the dialog inputs corresponding to the current optimization; the first dialog input set at least comprises the dialog inputs corresponding to an updated combination, and the first dialog input set meets the following predetermined condition: a number proportion of first-class dialog inputs is larger than that of second-class dialog inputs, the first-class dialog inputs are the dialog inputs corresponding to the updated combination, and the second-class dialog inputs are the dialog inputs corresponding to the combination without the update.

4. The method according to claim 3, wherein optimizing the generative dialog model comprises:
selecting some or all of the dialog inputs from the first dialog input set to form a second dialog input set, the second dialog input set meeting the predetermined condition;
generating replies corresponding respectively to the dialog inputs in the second dialog input set by the generative dialog model to form a first reply set, and optimizing the generative dialog model and a detection model according to the first reply set and the target safety specification;
selecting some or all of the dialog inputs from the first dialog input set to form a third dialog input set, the third dialog input set meeting the predetermined condition;
generating replies corresponding respectively to the dialog inputs in the third dialog input set by the optimized generative dialog model to form a second reply set, and optimizing the optimized generative dialog model again according to the second reply set and the optimized detection model, the detection model being configured to carry out safety detection on the replies generated.

5. The method according to claim 4,
wherein the first reply set comprises M replies generated for each dialog input in the second dialog input set, and M is a positive integer greater than one;
wherein optimizing the generative dialog model and the detection model according to the first reply set and the target safety specification comprises:
performing the following processing on any one dialog input in the second dialog input set: taking the dialog input as the to-be-processed dialog input, and acquiring each candidate reply corresponding to the to-be-processed dialog input and an manual annotation result of each candidate reply, a number of the candidate replies being greater than or equal to M, the candidate replies comprising the replies generated for the to-be-processed dialog input and/or replies obtained by manually modifying the replies generated for the to-be-processed dialog input, and the manual annotation result of each candidate reply comprising an annotation result obtained after safety annotation is manually performed on the candidate reply according to the target safety specification; constructing a training sample according to the to-be-processed dialog input, each candidate reply and the manual annotation result of each candidate reply, and optimizing the generative dialog model and the detection model by using the training sample.

6. The method according to claim 5,
wherein, for any one candidate reply, the annotation result after safety annotation comprises: evaluation labels of the candidate reply corresponding to different evaluation dimensions manually annotated according to the evaluation specifications of different evaluation dimensions of the combination corresponding to the to-be-processed dialog input, and the evaluation label indicates conformance to the corresponding evaluation specification or non-conformance to the corresponding evaluation specification.

7. The method according to claim 6, wherein constructing the training sample according to the to-be-processed dialog input, each candidate reply and the manual annotation result of each candidate reply, and optimizing the generative dialog model and the detection model by using the training sample comprises:
constructing first-class training samples and second-class training samples;
optimizing the generative dialog model by the first-class training samples in a supervised learning mode; and
optimizing the detection model by the second-class training samples in a supervised learning mode.

8. The method according to claim 7, wherein constructing the first-class training samples comprises:
selecting candidate replies meeting the following condition from the candidate replies: the evaluation labels of different evaluation dimensions all indicate conformance to the corresponding evaluation specification; and forming the first-class training samples by the selected candidate replies and the to-be-processed dialog input.

9. The method according to claim 7, further comprising:
obtaining a comprehensive score of each candidate reply, the higher the comprehensive score, the higher the safety;
wherein the detection model comprises a comprehensive detection model and classification detection models corresponding respectively to different evaluation dimensions;
the second-class training sample comprises a first-sub-class training sample and a second-sub-class training sample, the first-sub-class training sample comprises two candidate replies with different comprehensive scores, the to-be-processed dialog input, and a sample label, the sample label is used to indicate the candidate reply with a higher comprehensive score in the two candidate replies, and the second-sub-class training sample comprises one candidate reply, the to-be-processed dialog input and an evaluation label for the candidate reply;
optimizing the detection models comprises: optimizing the comprehensive detection model by using the first-sub-class training sample, and for any one classification detection model, optimizing the classification detection model by using the second-sub-class training sample comprising the evaluation label of the evaluation dimension corresponding to the classification detection model.

10. The method according to claim 4,
wherein the second reply set comprises the replies generated respectively for the dialog inputs in the third dialog input set;
wherein optimizing the optimized generative dialog model again according to the second reply set and the optimized detection model comprises:
performing safety detection on each reply in the second reply set by the optimized detection model, and optimizing the optimized generative dialog model again in a reinforcement learning manner according to a safety detection result of each reply.

11. The method according to claim 10,
wherein the detection models comprise a comprehensive detection model and classification detection models corresponding respectively to different evaluation dimensions;
wherein optimizing the optimized generative dialog model again in the reinforcement learning manner according to the safety detection result of each reply comprises:
performing the following processing for any one reply: obtaining a comprehensive detection result of the reply and classification detection results corresponding to different classification detection models respectively, determining a reward corresponding to the reply by combining the comprehensive detection result and the different classification detection results, and forming a training sample by using the reply, the dialog input corresponding to the reply and the reward; and
optimizing the optimized generative dialog model again by using the training samples.

12. The method according to claim 11, wherein optimizing the optimized generative dialog model again by using the training samples comprises:
using the optimized generative dialog model as a baseline model, and generating a target model identical to the baseline model; and
optimizing the target model using the training sample based on a constraint of a Kullback-Leibler divergence introduced between the baseline model and the target model, and using the optimized target model as the generative dialog model optimized again.

13. A generative dialog implementing method, comprising:
obtaining a to-be-processed dialog input; and
generating a reply corresponding to the to-be-processed dialog input by using a generative dialog model, the generative dialog model being obtained after N optimization iterations and conforming to a launch requirement, N being a positive integer greater than one, and each optimization iteration comprising: optimization performed on the generative dialog model according to a determined dialog input and a principle that a reply generated by the generative dialog model conforms to a target safety specification in response to determination of an update of a safety specification, the target safety specification being an updated safety specification, the determined dialog input corresponding to a current optimization determined according to the target safety specification, and the update being performed on a previous safety specification when the generative dialog model after last optimization is determined not to meet the launch requirement.

14. An electronic device, comprising:
at least one processor; and
a memory connected with the at least one processor communicatively;
wherein the memory stores instructions executable by the at least one processor to cause the at least one processor to perform a generative dialog model training method comprising:
in response to determination of an update of a safety specification, taking an updated safety specification as a target safety specification, and determining a dialog input corresponding to a current optimization according to the target safety specification, the update being performed on a previous safety specification when a generative dialog model after last optimization is determined not to meet a launch requirement; and
optimizing the generative dialog model according to the dialog input and a principle that a reply generated by the generative dialog model conforms to the target safety specification, the generative dialog model being configured to generate the reply corresponding to the dialog input.

15. The electronic device according to claim 14, wherein the safety specification comprises an evaluation specification of at least one evaluation dimension corresponding to different combinations respectively, any one combination consists of one content field and one application scenario, the content field is a safe content field involved by a generative dialog, and the application scenario is an application scenario of the generative dialog;
the update of the safety specification comprises one or any combination of: addition of a combination and an evaluation specification of at least one corresponding evaluation dimension, addition of an evaluation dimension and a corresponding evaluation specification for a previous combination, and adjustment of the previous evaluation specification.

16. The electronic device according to claim 15, wherein determining the dialog input corresponding to the current optimization according to the target safety specification comprises:
obtaining a first dialog input set, and taking dialog inputs therein as the dialog inputs corresponding to the current optimization; the first dialog input set at least comprises the dialog inputs corresponding to an updated combination, and the first dialog input set meets the following predetermined condition: a number proportion of first-class dialog inputs is larger than that of second-class dialog inputs, the first-class dialog inputs are the dialog inputs corresponding to the updated combination, and the second-class dialog inputs are the dialog inputs corresponding to the combination without the update.

17. The electronic device according to claim 16, wherein optimizing the generative dialog model comprises:
selecting some or all of the dialog inputs from the first dialog input set to form a second dialog input set, the second dialog input set meeting the predetermined condition;
generating replies corresponding respectively to the dialog inputs in the second dialog input set by the generative dialog model to form a first reply set, and optimizing the generative dialog model and a detection model according to the first reply set and the target safety specification;
selecting some or all of the dialog inputs from the first dialog input set to form a third dialog input set, the third dialog input set meeting the predetermined condition;
generating replies corresponding respectively to the dialog inputs in the third dialog input set by the optimized generative dialog model to form a second reply set, and optimizing the optimized generative dialog model again according to the second reply set and the optimized detection model, the detection model being configured to carry out safety detection on the replies generated.

18. An electronic device, comprising:
at least one processor; and
a memory connected with the at least one processor communicatively;
wherein the memory stores instructions executable by the at least one processor to cause the at least one processor to perform the method according to claim 13.

19. A non-transitory computer readable storage medium storing computer instructions for causing a computer to perform the method according to claim 1.

20. A non-transitory computer readable storage medium storing computer instructions for causing a computer to perform the method according to claim 13.
